(19) United States
(12) Patent Application Publication
(10) Pub. No.: US 2023/0348271 A1
(43) Pub. Date: Nov. 2, 2023

(54) COMPOSITION FOR GENERATING OXYGEN, OXYGEN GENERATOR, AND METHOD OF GENERATING OXYGEN

(71) Applicant: Diehl Aviation Gilching GmbH, Gilching (DE)

(72) Inventors: Christoph Kallfass, Schwäbisch Hall (DE); Lars Fritze, Würzburg (DE); Jan A. P. Sprenger, Ochsenfurt (DE); Maik Finze, Waldbrunn (DE)

(21) Appl. No.: 18/306,272

(22) Filed: Apr. 25, 2023

(30) Foreign Application Priority Data
Apr. 27, 2022 (DE) 10 2022 110 174.6

(51) Int. Cl. C01B 13/02

(52) U.S. Cl. CPC C01B 13/0207; C01B 13/0296

(57) ABSTRACT

A composition for generating oxygen includes the following constituents. Potassium superoxide forming an oxygen source. An ionic liquid, which is a salt with at least one cation and at most 100 cations and with at least one anion and at most 100 anions. The composition additionally has a water-containing solution or a water-containing mixture. The water-containing solution contains such an amount of a further salt or such an amount of a further salt together with such an amount of an antifreeze or the water-containing mixture contains such an amount of an antifreeze, that the freezing point of the solution or of the mixture is lowered by at least 10° C. compared to the freezing point of the water.

### CROSS-REFERENCE TO RELATED APPLICATION

This application claims the priority, under 35 U.S.C. § 119, of German Patent Application DE 10 2022 110 174.6, filed Apr. 27, 2022; the prior application is herewith incorporated by reference in its entirety.

### FIELD AND BACKGROUND OF THE INVENTION

The present invention relates to a composition for generating oxygen, in particular breathable oxygen, to an oxygen generator, to a method for generating oxygen, in particular breathable oxygen, and to the use of the composition. The composition comprises an oxygen source and an ionic liquid.

Humans cannot survive without oxygen. However, in many environments the supply of oxygen is insufficient or there is a risk of an emergency situation that involves a lack of oxygen. In order to generate breathable oxygen, it is possible to use various types of chemical oxygen generators. One type of such a chemical oxygen generator uses peroxides as the oxygen source, for example sodium percarbonate, sodium perborate, or a urea adduct of hydrogen peroxide. The decomposition of the peroxides yields oxygen and the decomposition reaction can be started by bringing the peroxide compounds into contact with a suitable enzyme or transition metal catalyst. Chemical oxygen generators of this kind are disclosed in U.S. Pat. No. 2,035,896, WO 86/02063 A1, JP S61227903 A, and DE 196 02 149 A1.

European published patent application EP 3 323 782 A1 discloses ionic liquids that are used as solvent in an oxygen-generating composition. The composition comprises at least one oxygen source, at least one ionic liquid, and at least one metal oxide compound. The oxygen source comprises a peroxide compound and the ionic liquid is in the liquid state at least in a temperature range from −10° C. to +50° C. The metal oxide compound is an oxide of a single metal or of two or more different metals. The metal(s) is/are g selected from the metals of groups 2 to 14 of the periodic table of the elements.

European published patent application EP 3 323 470 A1 discloses an apparatus for generating oxygen comprising at least one reaction chamber for receiving a composition for generating oxygen. This composition comprises a peroxide compound as the oxygen source and a formulation of an ionic liquid that comprises an ionic liquid having a cation and a metallate anion. The apparatus additionally comprises means for physically separating and means for producing physical contact between the oxygen source and the formulation of the ionic liquid, and also means enabling oxygen to exit from the reaction chamber.

European patent EP 3 604 212 B1 discloses an oxygen generator that comprises a composition for generating oxygen and at least one tuner compact body having a core-shell structure. The tuner compact body comprises a compound selected from a peroxide decomposition catalyst, an acidic compound or a basic compound. The composition for generating oxygen comprises a peroxide as the oxygen source, an ionic liquid, a metal oxide compound and/or a metal salt as decomposition catalyst and, if the ionic liquid is an acidic liquid, a basic compound. EP 3 604 212 B1 also discloses a method for adjusting the oxygen production rate of the composition for generating oxygen.

International patent application WO 2006/001607 A1 discloses oxygen-generating compositions comprising potassium superoxide or sodium peroxide, a material for stabilizing the reactivity and the oxidizing power of potassium superoxide or sodium peroxide and optionally at least one catalyst selected from an oxidation catalyst for carbon monoxide, a material for improving moldability and processibility of the composition and a material for increasing the initial carbon dioxide absorption rate. The material for stabilizing the reactivity and the oxidizing power of potassium superoxide or sodium peroxide is selected from calcium hydroxide, aluminum hydroxide, magnesium hydroxide, barium hydroxide, calcium carbonate, talc and clay. The catalyst for the oxidation of carbon monoxide is selected from copper oxide, manganese oxide and a mixture thereof (hopcalite). The material for improving the moldability and processibility of the oxygen-generating compositions is selected from glass powder, glass fibers, ceramic fibers, steel wool, bentonite, kaolinite, sodium silicate and potassium silicate.

U.S. Pat. No. 4,490,274 discloses a chemical composition comprising oxygenic ingredients and activators which, when activated, generate oxygen for use in breathing mixtures, the oxygenic ingredients being potassium superoxide and sodium peroxide and the activators being aluminum hydroxide, manganese dioxide and powdered aluminum. The ratio of the chemical composition corresponds to 10-20% by weight sodium peroxide, 15-25% by weight aluminum hydroxide, 5-7% by weight manganese oxide, 2.5-3.5% by weight aluminum powder. The remaining proportion of the chemical composition corresponds to potassium superoxide.

Published patent application US 2017/0263989 A1 discloses an electrochemical lithium-air cell. The battery comprises an anode space, a cathode space and a lithium ion-conducting membrane separating the anode space form the cathode space. The anode chamber comprises an anode comprising lithium, a lithium alloy or a porous material that can adsorb and release lithium, and a lithium ion electrolyte, while the cathode chamber comprises an air electrode, an ionic liquid that can facilitate the reduction of oxygen, and a dissolved concentration of potassium superoxide. The lithium ion concentration in the cathode space is low compared to the potassium ion concentration.

Published patent application US 2019/0016597 A1 discloses a method for generating oxygen in an ionic liquid by means of an oxygen source and a metal salt as catalyst. Oxygen sources given are alkali metal percarbonates, alkali metal perborates, urea hydrogen peroxide and mixtures thereof. The method enables the generation of oxygen in the absence of water at a relatively low temperature.

U.S. Pat. No. 4,963,327 discloses an apparatus and a method for selectively absorbing undesired organic and inorganic vapors and gases from ambient air while simultaneously increasing the oxygen content of the treated air. The absorption of carbon dioxide is here performed by a solid carbon dioxide absorber, which can be lithium hydroxide. Examples of oxygen-generating compounds mentioned are alkali metal and alkaline earth metal peroxides, superoxides, trioxides, percarbonates, permanganates and mixtures thereof. The reaction of these compounds with the moisture from the respiratory air is sufficient for oxygen release in the case of slow breathing. In the event of rapid breathing, the oxygen-generating compound is supplied with an aqueous solution of MgCl₂ comprising a small amount of surfactant from an attached reservoir. The MgCl₂ serves here as an antifreeze agent and as a decomposition agent for the alkaline salts from the oxygen-generating compound/water/carbon dioxide reaction. An insoluble gel of magnesium hydroxide/carbonate is formed together with pH-neutral salt. Instead of MgCl₂, it is possible to use other salts that bring about reductions in the freezing point in aqueous solutions, if they form essentially insoluble compounds in a reaction with alkali metal hydroxides and/or alkali metal carbonates. Examples include CaCl₂, FeCl₃ and ZnCl₂.

### SUMMARY OF THE INVENTION

It is accordingly an object of the invention to overcome a variety of the above-mentioned disadvantages of the heretofore-known devices and methods of this general type and to provide an alternative composition for generating oxygen and an alternative oxygen generator. It is a further object to specify a novel method and a use for generating oxygen.

With the above and other objects in view there is provided, in accordance with the invention, a composition for generating oxygen that comprises, or consists of, the following constituents:
an oxygen source, said oxygen source being potassium superoxide;
an ionic liquid, said ionic liquid being a salt consisting of at least one cation and at most 100 cations, and at least one anion and at most 100 anions;
a water-containing solution or a water-containing mixture, said water-containing solution containing a given amount of a further salt or a given amount of the further salt together with a given amount of an antifreeze, or the water-containing mixture contains a given amount of an antifreeze, to effectively lower a freezing point of said water-containing solution or of said water-containing mixture by at least 10° C. compared with a freezing point of the water;
said further salt of said water-containing solution being an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two compounds selected from the group consisting of an alkali metal hydroxide, an alkali metal hydroxide hydrate, an alkali metal chloride, an alkali metal chloride hydrate, a hydroxide with an organic cation, and a hydrate of a hydroxide with an organic cation; and
said antifreeze includes an alcohol or consists of an alcohol.

In other words, the invention relates to a composition for generating oxygen, wherein the composition comprises or consists of the following constituents: an oxygen source, the oxygen source being potassium superoxide, an ionic liquid, which is a salt consisting of at least one cation and at most 100 cations and at least one anion and at most 100 anions, and a water-containing solution or a water-containing mixture, wherein the water-containing solution contains such an amount of a further salt or such an amount of a further salt together with such an amount of an antifreeze or the water-containing mixture contains such an amount of an antifreeze, that the freezing point of the solution or of the mixture is lowered by at least 10° C. compared to the freezing point of the water. The further salt of the water-containing solution is an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two selected from an alkali metal hydroxide, an alkali metal hydroxide hydrate, an alkali metal chloride, an alkali metal chloride hydrate, a hydroxide with an organic cation and a hydrate of a hydroxide with an organic cation. The antifreeze comprises an alcohol or consists of an alcohol.

The further salt can be a salt present in the form of a solid. The ionic liquid can be a salt consisting of at most 80 cations, in particular at most 60 cations, in particular at most 40 cations, in particular at most 20 cations, in particular at most ten cations, in particular at most nine cations, in particular at most eight cations, in particular at most seven cations, in particular at most six cations, in particular at most five cations, in particular at most four cations, in particular at most three cations, in particular at most two cations, and of at most 80 anions, in particular at most 60 anions, in particular at most 40 anions, in particular at most 20 anions, in particular at most ten anions, in particular at most nine anions, in particular at most eight anions in particular at most seven anions, in particular at most six anions, in particular at most five anions, in particular at most four anions, in particular at most three anions, in particular at most two anions. In particular, the ionic liquid can be a salt consisting of one or two cations and one or two anions. In one configuration, the ionic liquid has just one cation and/or just one anion. The ionic liquid has a melting point of less than 100° C. It may be an ionic liquid that is liquid at 85° C., in particular at 50° C., in particular at 0° C., in particular at −50° C. Here and hereinafter, the term “cation” is understood to mean a multiplicity of cations of the same type and the term “anion” is understood to mean a multiplicity of anions of the same type. For example, the feature “salt consisting of at least one cation and at most ten cations and at least one anion and at most ten anions” means that the salt consists of a multiplicity of cations of at least one type and at most ten types and of a multiplicity of anions of at least one type and at most ten types.

The water-containing solution can, in the simplest case, consist only of water and the further salt, or of water, the further salt and the antifreeze. The water-containing mixture can in the simplest case consist only of water and the antifreeze.

For the generation of oxygen, the composition according to the invention does not require any peroxide compound as oxygen source or any metal oxide compound, in particular any metal oxide compound as catalyst or any oxidation catalyst for carbon monoxide. In one configuration, the composition according to the invention also does not comprise any of the compounds mentioned or any oxidation catalyst for carbon monoxide. The composition according to the invention differs greatly from the compositions for generating oxygen that are known from known from EP 3 323 782 A1, EP 3 323 470 A1, EP 3 604 212 B1, WO 2006/001607 A1 and U.S. Pat. No. 4,490,274.

In contrast to the non-aqueous composition known from US 2017/0263989 A1 in the electrochemical lithium-air cell, the composition according to the invention for generating oxygen comprises a water-containing solution or a water-containing mixture. If the composition in the lithium-air cell contained water, it would form oxygen and destroy the lithium-air cell.

In contrast to the method known from US 2019/0016597 A1, in the composition according to the invention and in the method according to the invention the presence of water in the water-containing solution or water-containing mixture is essential for the release of the oxygen. In the method known from US 2019/0016597 A1, the object of generating oxygen at low temperatures is achieved in an alternative manner through the avoidance of water.

In contrast to the apparatus known from U.S. Pat. No. 4,963,327, the composition according to the invention does not contain any salt that forms essentially insoluble compounds on reaction with alkali metal hydroxides and/or alkali metal carbonates. In the composition according to the invention and the method according to the invention that is performed using said composition, the mass formation of insoluble reaction products would lead to reduced contact of the potassium superoxide with water and hence to a reduced generation of oxygen.

The method according to the invention ensures a generation of oxygen by way of the composition according to the invention which is scalable even at very low temperatures. At the same time, the composition according to the invention generates oxygen continuously and uniformly and in a relatively broad temperature range, in particular in a temperature range from −40° C. to +70° C. The continuous and uniform generation of oxygen can be ensured in this case over a comparatively long period of time.

The oxygen can be breathable oxygen, especially for use in emergencies. In this case, a composition from which oxygen can be generated only in traces or as a mixture with another, non-breathable, gas, such as carbon monoxide, ammonia, chlorine or a chlorine compound or two or more chlorine compounds, would not be a composition for generating breathable oxygen.

The oxygen source is potassium superoxide. The oxygen source is always a solid at room temperature and in a temperature range possibly encountered for an emergency oxygen generator.

The ionic liquid is not a solution of a salt in a solvent, such as water, but instead a salt that has a melting point of less than 100° C. and in particular is in the liquid state even at a temperature of much less than 100° C. The cation or one of the cations can be an ammonium ion, a substituted ammonium ion, in particular a tetraalkylammonium ion, a phosphonium ion, a substituted phosphonium ion, in particular a tetraalkylphosphonium ion, an N-monosubstituted or an N-disubstituted pyrrolidinium ion, an N-monosubstituted or an N′,N-disubstituted imidazolium ion or an N-monosubstituted pyridinium ion. The anion or one of the anions can be a halide ion, a tetrafluoroborate ion, a hexafluorophosphate ion, a cyanoborate ion, a substituted cyanoborate ion, in particular a perfluoroalkylcyanoborate ion, a sulfonate ion, in particular a perfluoroalkylsulfonate ion, a bisperfluoroalkylimide ion, a borate ion, a substituted borate ion, in particular a perfluoroalkylborate ion, a phosphate ion, a substituted phosphate ion, in particular a perfluoroalkylphosphate ion, or a perfluoroalkylfluorophosphate ion. The name element “perfluoroalkyl” denotes in general an aliphatic substance in which all hydrogen atoms bonded to carbon atoms of the unfluorinated substance derived therefrom are replaced by fluorine atoms, except for the hydrogen atoms that when substituted would change the nature of the functional groups present.

In one embodiment of the invention, a substituent of the N-monosubstituted pyrrolidinium ion, of the N-monosubstituted imidazolium ion and of the N-monosubstituted pyridinium ion, and at least one substituent of the N′,N-disubstituted imidazolium ion, and at least one substituent of the N-disubstituted pyrrolidinium ion, is independently selected from alkyl, in particular methyl, ethyl, propyl or butyl, benzyl and aryl.

The bis(perfluoroalkyl)imide ion can be an ion having the general formula [N(SO₂R^{F}ₓ)₂]—, where x indicates the number of carbon atoms in the perfluoroalkyl substituent R^{F}. Preferably, x=1.

The perfluoroalkyl substituent R^{F} here has the general formula CₓF₂ₓ₊₁. If x=1, the perfluoroalkyl substituent is perfluoromethyl having the molecular formula —CF₃. If x=2, the perfluoroalkyl substituent is perfluoroethyl having the molecular formula —C₂F₅. If x=3, the perfluoroalkyl substituent is perfluoropropyl having the molecular formula —C₃F₇.

The (perfluoroalkyl)(fluoro)(cyano)borate ion can be an ion having the general formula [R^{F}ₓBF_{y}(CN)_{z}]⁻, where x=0-4, where y=0-3, where z=0-4, where x+y+z=4. If x=0, it is a fluorocyanoborate ion. If y=0, it is a perfluoroalkylcyanoborate ion. If z=0, it is a perfluoroalkylfluoroborate ion. If x=0 and y=0, it is a tetracyanoborate ion. If x=0 and z=0, it is a tetrafluoroborate ion. If y=0 and z=0, it is a tetrakis(perfluoroalkyl)borate ion.

The perfluoroalkyl(fluoro)phosphate ion can be an ion having the general formula [R^{F}ₓPF₆₋ₓ]⁻, where x=1-3. If x=0, it is a hexafluorophosphate ion.

The inventors have found that an ionic liquid, especially an ionic liquid that contains an N-disubstituted pyrrolidinium ion having at least one alkyl substituent, especially methyl or butyl, or having two different alkyl substituents, especially methyl and butyl, is advantageous. The inventors have further found that an ionic liquid, especially an ionic liquid that contains a relatively hydrophobic anion, in particular a cyanoborate ion, a perfluoroalkylcyanoborate ion, a perfluoroalkylsulfonate ion, a bisperfluoroalkylimide ion, a perfluoroalkylborate ion, a perfluoroalkylphosphate ion, or a perfluoroalkylfluorophosphate ion, is advantageous. A cation having at least one alkyl substituent and/or a relatively hydrophobic anion ensures a relatively high hydrophobicity of the ionic liquid. A relatively high hydrophobicity of the ionic liquid ensures a relatively low hygroscopicity of the ionic liquid. The inventors have further found that a relatively low hygroscopicity of the ionic liquid in the composition according to the invention ensures a relatively high stability of the relatively hydrolysis-sensitive potassium superoxide. The inventors have furthermore found that an ionic liquid, especially an ionic liquid that contains a halide ion, a tetrafluoroborate ion, a hexafluorophosphate ion, a perfluoroalkylcyanoborate ion, in particular a perfluoroalkylsulfonate ion, a bisperfluoroalkylimide ion, a perfluoroalkylborate ion, a perfluoroalkylphosphate ion or a perfluoroalkylfluorophosphate ion additionally ensures a relatively high electrochemical stability of the ionic liquid. The inventors assume that the relatively high electrochemical stability is in particular ensured by electronegative substituents, especially fluorine substituents, perfluoroalkyl substituents and cyano substituents. The inventors have furthermore found that a relatively high electrochemical stability of the ionic liquid prevents the ionic liquid from entering into a reaction with a reactive ion species, in particular superoxide ions, in the composition according to the invention.

The inventors have also found that an ionic liquid, especially an ionic liquid that contains an N-disubstituted pyrrolidinium ion and/or a relatively hydrophobic anion, in particular a cyanoborate ion, a perfluoroalkylcyanoborate ion, a perfluoroalkylsulfonate ion, a bisperfluoroalkylimide ion, a perfluoroalkylborate ion, a perfluoroalkylphosphate ion, or a perfluoroalkylfluorophosphate ion, in the composition according to the invention ensures a relatively uniform generation of oxygen over a relatively long period of time.

The ionic liquid can be an ionic liquid that is in the liquid state in a temperature range from −60° C. to +150° C., in particular in a temperature range from −55° C. to +140° C., in particular in a temperature range from −50° C. to +130° C., in particular in a temperature range from −45° C. to +120° C., in particular in a temperature range from −40° C. to +110° C., in particular in a temperature range from −35° C. to +100° C., in particular in a temperature range from −30° C. to +90° C., in particular in a temperature range from −25° C. to +80° C., in particular in a temperature range from −20° C. to +70° C.

Examples of suitable ionic liquids are [BMPL]Cl, [BMPL][CF₃SO₃], [BMPL][C₂F₅SO₃], [BMPL][C₄F₉SO₃], [BMPL][N(SO₂CF₃)₂], [BMPL][BF₄], [BMPL][BF₂(CN)₂], [BMPL][BF(CN)₃], [BMPL][B(CN)₄], [BMPL][CF₃BF₃], [BMPL][C₂F₅BF₃], [BMPL][CF₃BF₂(CN)], [BMPL][C₂F₅BF₂(CN)], [BMPL][CF₃BF(CN)₂], [BMPL][C₂F₅BF(CN)₂], [BMPL][CF₃B(CN)₃], [BMPL][C₂F₅B(CN)₃], [BMPL][PF₆], [BMPL][C₂F₅PF₅], [BMPL][(C₂F₅)₂PF₄], [BMPL][(C₂F₅)₃PF₃], [HMIm]Cl, [HMIm][CF₃SO₃], [HMIm][C₂F₅SO₃], [HMIm][C₄F₉SO₃], [HMIm][N(SO₂CF₃)₂], [HMIm][BF₄], [HMIm][BF₂(CN)₂], [HMIm][BF(CN)₃], [HMIm][B(CN)₄], [HMIm][CF₃BF₃], [HMIm][C₂F₅BF₃], [HMIm][CF₃BF₂(CN)], [HMIm][C₂F₅BF₂(CN)], [HMIm][CF₃BF(CN)₂], [HMIm][C₂F₅BF(CN)₂], [HMIm][CF₃B(CN)₃], [HMIm][C₂F₅B(CN)₃], [HMIm][PF₆], [HMIm][C₂F₅PF₅], [HMIm][(C₂F₅)₂PF₄], [HMIm][(C₂F₅)₃PF₃], [BMIm]Cl, [BMIm][CF₃SO₃], [BMIm][C₂F₅SO₃], [BMIm][C₄F₉SO₃], [BMIm][N(SO₂CF₃)₂], [BMIm][BF4], [BMIm][BF₂(CN)₂], [BMIm][BF(CN)₃], [BMIm][B(CN)₄], [BMIm][CF₃BF₃], [BMIm][C₂F₅BF₃], [BMIm][CF₃BF₂(CN)], [BMIm][C₂F₅BF₂(CN)], [BMIm][CF₃BF(CN)₂], [BMIm][C₂F₅BF(CN)₂], [BMIm][CF₃B(CN)₃], [BMIm][C₂F₅B(CN)₃], [BMIm][PF₆], [BMIm][C₂F₅PF₅], [BMIm][(C₂F₅)₂PF₄], [BMIm][(C₂F₅)₃PF₃], [EMIm][CF₃SO₃], [EMIm][C₂F₅SO₃], [EMIm][C₄F₉SO₃], [EMIm][N(SO₂CF₃)₂], [EMIm][BF₄], [EMIm][BF₂(CN)₂], [EMIm][BF(CN)₃], [EMIm][B(CN)₄], [EMIm][CF₃BF₃], [EMIm][C₂F₅BF₃], [EMIm][CF₃BF₂(CN)], [EMIm][C₂F₅BF₂(CN)], [EMIm][CF₃BF(CN)₂], [EMIm][C₂F₅BF(CN)₂], [EMIm][CF₃B(CN)₃], [EMIm][C₂F₅B(CN)₃], [EMIm][PF₆], [EMIm][C₂F₅PF₅], [EMIm][(C₂F₅)₂PF₄], and [EMIm][(C₂F₅)₃PF₃]. Further examples of suitable ionic liquids are [MMIm][SO4Me], [EMIm][SO4Et], [BMIm][SO4Me], [BMIm][SO4Bu], [MMIm][PO4Me2], [EMIm][PO4Et2], [EEIm][PO4Et2], [BMIm][PO4Me2], [BMIm][PO4Bu2], [EMIm][H2PO4], [EMIm][HSO4], [BMIm][FeCl4], and [BMIm][BF4], [BMIm][PF6], [HMIm][BF4], [HMIm][PF6].

The following nomenclature applies in the above: The first square brackets contain the cation and the second square brackets contain the anion.

The following established abbreviations also apply: BMPL: 1-butyl-1-methylpyrrolidinium, BMIm: 1-butyl-3-methylimidazolium, HMIm: 1-hexyl-3-methylimidazolium, EMIm: 1-ethyl-3-methylimidazolium, SO4Me: methylsulfate, SO4Et: ethylsulfate, SO4Bu: butylsulfate, PO4Me2: dimethylphosphate, PO4Et2: diethylphosphate, PO4Bu2: dibutylphosphate, HSO4: hydrogensulfate, H2PO4: dihydrogenphosphate, FeCl4: tetrachloroferrate, BF4: tetrafluoroborate and PF6: hexafluorophosphate.

Three different ionic liquids with structural formulas are shown below for illustration purposes.

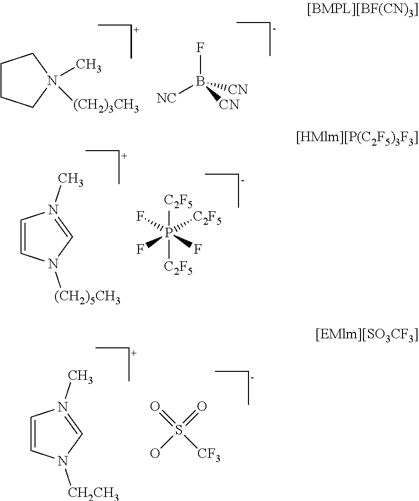

The water-containing solution can contain such an amount of the further salt or of the further salt together with such an amount of the antifreeze or the water-containing mixture can contain such an amount of the antifreeze, that the freezing point of the solution or of the mixture is lowered by at least 15° C., in particular by at least 20° C., in particular by at least 25° C., in particular by at least 30° C., in particular by at least 35° C., in particular by at least 40° C., in particular by at least 45° C., in particular by at least 50° C., compared to the freezing point of the water. The water-containing solution or the water-containing mixture is a low-freezing solution or a low-freezing mixture, respectively. As a result of the fact that the freezing point is lowered to a relatively low temperature, oxygen generation is ensured at relatively low temperatures by virtue of the liquid state of the water-containing solution or of the water-containing mixture.

The alkali metal hydroxide can be lithium hydroxide, sodium hydroxide, potassium hydroxide, rubidium hydroxide or cesium (IUPAC caesium) hydroxide. The alkali metal hydroxide can in particular be potassium hydroxide. The alkali metal hydroxide hydrate can be a hydrate of lithium hydroxide, a hydrate of sodium hydroxide, a hydrate of potassium hydroxide, a hydrate of rubidium hydroxide or a hydrate of cesium hydroxide. The alkali metal chloride can be lithium chloride, sodium chloride, potassium chloride, rubidium chloride or cesium chloride. The alkali metal chloride hydrate can be a hydrate of lithium chloride. The hydroxide with an organic cation can be a tetraalkylammonium hydroxide. The tetraalkylammonium hydroxide can be tetramethylammonium hydroxide, tetraethylammonium hydroxide, tetrapropylammonium hydroxide, tetrabutylammonium hydroxide, triethylmethylammonium hydroxide, tetrapentylammonium hydroxide or tetrahexylammonium hydroxide. The hydrate of a hydroxide with an organic cation can be a hydrate of a tetraalkylammonium hydroxide. The hydrate of the tetraalkylammonium hydroxide can be a hydrate of tetramethylammonium hydroxide, a hydrate of tetraethylammonium hydroxide, a hydrate of tetrapropylammonium hydroxide, a hydrate of tetrabutylammonium hydroxide, a hydrate of triethylmethylammonium hydroxide, a hydrate of tetrapentylammonium hydroxide or a hydrate of tetrahexylammonium hydroxide.

The tetraalkylammonium hydroxide or the hydrate of the tetraalkylammonium hydroxide can be present dissolved in water or in a monohydric alcohol, in particular methanol, ethanol, propanol or isopropanol. The total weight of the tetraalkylammonium hydroxide or of the hydrate of the tetraalkylammonium hydroxide in relation to the total weight of the solution or of the mixture can be at least 5% by weight and at most 80% by weight, in particular at least 10% by weight and at most 70% by weight, in particular at least 20% by weight and at most 60% by weight, in particular at least 30% by weight and at most 50% by weight.

The antifreeze can comprise a monohydric alcohol, in particular ethanol or octanol, a dihydric alcohol, in particular propylene glycol or ethylene glycol, a trihydric alcohol, in particular glycerol, or a mixture of at least two selected from a monohydric alcohol, in particular ethanol or octanol, a dihydric alcohol, in particular propylene glycol or ethylene glycol, and a trihydric alcohol, in particular glycerol. Alternatively, the antifreeze can consist of a monohydric alcohol, in particular ethanol or octanol, a dihydric alcohol, in particular propylene glycol or ethylene glycol, a trihydric alcohol, in particular glycerol, or a mixture of at least two selected from a monohydric alcohol, in particular ethanol or octanol, a dihydric alcohol, in particular propylene glycol or ethylene glycol, and a trihydric alcohol, in particular glycerol.

The total weight of the further salt or the total weight of the further salt together with the total weight of the antifreeze in the water-containing solution in relation to the total weight of the water-containing solution or the total weight of the antifreeze in the water-containing mixture in relation to the total weight of the water-containing mixture can be at least 5% by weight, in particular at least 10% by weight, in particular at least 15% by weight, in particular at least 20% by weight, in particular at least 25% by weight, in particular at least 28% by weight, in particular at least 30% by weight, in particular at least 35% by weight, in particular at least 40% by weight, in particular at least 45% by weight, in particular at least 50% by weight. The maximum total weight of the further salt in relation to the total weight of the water-containing solution is reached when the water-containing solution is saturated with the further salt. The water-containing solution can be a saturated aqueous solution of the further salt of the water-containing solution. A saturated aqueous solution of the further salt of the water-containing solution is understood to be an aqueous solution of the further salt in which, for a given temperature, the maximum possible amount of the further salt is present in dissolved form. In the water-containing solution, the further salt can also be present in such an amount that the further salt in the water-containing solution is present partly in undissolved form, in particular in the form of a suspension.

The inventors have found that a relatively high total weight of the further salt or of the further salt together with the total weight of the antifreeze of the water-containing solution or of the antifreeze in the water-containing mixture in relation to the total weight of the water-containing solution or mixture, with the resulting relatively low freezing point of the solution or mixture, enables sufficient oxygen generation even at a temperature well below 0° C. Oxygen generation is made possible as a result of the liquid state of the solution or mixture at relatively low temperatures. The further salt and/or the antifreeze can be present in the solution or mixture at such a concentration that the water-containing solution or mixture is liquid at a temperature in a temperature range from −80° C. to 0° C., in particular at a temperature in a temperature range from −60° C. to 0° C., in particular at a temperature in a temperature range from −50° C. to −10° C., in particular at a temperature in a temperature range from −40° C. to −20° C., in particular at a temperature in a temperature range from −35° C. to −25° C. This ensures the generation of oxygen by the composition according to the invention even at relatively low temperatures, especially at a temperature within the afore-mentioned temperature ranges.

The further salt in the water-containing solution can in particular be potassium hydroxide. The inventors have found that, with a total weight of the potassium hydroxide of 25% by weight relative to the total weight of the water-containing solution, the freezing point of the water-containing solution is −40° C. The inventors have also found that, with a total weight of the potassium hydroxide of 28% by weight relative to the total weight of the water-containing solution, the freezing point of the aqueous solution of the further salt is −50° C. They have further found that the composition generates oxygen for as long as the water-containing solution or mixture is liquid, i.e., even at a temperature which is only so slightly above the freezing point that the water-containing solution or mixture is still liquid.

The oxygen source can be present, in particular as pure substance, in solid form. In particular, it can be present as a pure substance in solid form at 25° C. The oxygen source can be present in the ionic liquid, in particular in an anhydrous ionic liquid, in suspended form, in particular in the form of a paste. The oxygen source and the ionic liquid, in particular an anhydrous ionic liquid, can be present in a form pressed with one another, with the (in particular anhydrous) ionic liquid serving as a binder. The oxygen source and the ionic liquid can be present as a result as a solid-form shaped body formed by pressing. The ionic liquid is considered to be anhydrous not only when it contains no water, but also when it contains only traces of water, in particular a water content of not more than 1% by weight, in particular of not more than 0.5% by weight, in particular of not more than 0.1% by weight, in particular of not more than 0.05% by weight, in particular of not more than 0.01% by weight, in particular of not more than 0.005% by weight, in particular of not more than 0.001% by weight.

The inventors have found that in the composition according to the invention no chemical reaction takes place between the oxygen source and the anhydrous ionic liquid, or at the most a chemical reaction takes place until the water present in traces has been consumed. In addition, as a result of the oxygen source being present in the ionic liquid in suspended form, in particular in the form of a paste, or as a result of the oxygen source and the ionic liquid being present in pressed form with the ionic liquid as binder, it is ensured that the oxygen source is protected relatively well against undesired contact with water, in particular with atmospheric humidity. The protective effect of the ionic liquid, in particular an anhydrous ionic liquid, is stronger the more hydrophobic the ionic liquid is. On contact of the oxygen source with water, in particular with atmospheric humidity, the water reacts with the oxygen source hydrolytically. The hydrolytic reaction of the oxygen source leads to an undesired release of oxygen as a result of decomposition of the oxygen source. The protective effect of the ionic liquid ensures a relatively high stability of the oxygen source with respect to atmospheric humidity.

The inventors have moreover found that the presence of an oxygen source in suspended form in the ionic liquid, in particular in the form of a paste, or the presence of the oxygen source and the ionic liquid in pressed form with the ionic liquid as a binder, can ensure a relatively uniform generation of oxygen over a relatively long period of time, in particular over a period of time of at least 2 hours, in particular over a period of time of at least 2.5 hours, in particular over a period of time of at least 3 hours, in particular over a period of time of at least 3.5 hours.

In one embodiment of the invention, the composition comprises, as further constituent, at least one additive. The additive can be independently selected from sodium dihydrogenphosphate or potassium hydroxide present in solid form, an additional substance and an antifoam. The additional substance can be a phyllosilicate, in particular mica, or fumed silica. The antifoam can comprise or consist of octanol, paraffin wax or a polysiloxane. The oxygen source and the additive can be present together in pressed form. The oxygen source and the additive can be present together in a solid-form shaped body formed by pressing. The additive can be an additive serving either for accelerating or for slowing the generation of oxygen. By way of example, an acidic additive such as for example sodium dihydrogenphosphate present as a solid has the effect of accelerating oxygen generation and a basic additive such as for example potassium hydroxide present as a solid has the effect of slowing oxygen generation. Fumed silica can additionally be used to suppress floating of the oxygen source during the reaction for generating oxygen in the water-containing solution or in the water-containing mixture. This works particularly well when the oxygen source and the fumed silica are present together in a shaped body formed by pressing. As a result of suppressing floating of the oxygen source, a relatively uniform decomposition of the oxygen source is ensured during the reaction for generating oxygen in the water-containing solution or in the water-containing mixture. The antifoam can suppress foam formation during the generation of the oxygen and/or destroy foam that has formed during the generation of the oxygen. At least one additive can be present in the composition in a form that brings about a delayed release of the additive. For example, the additive may to this end be encapsulated in a capsule that slowly dissolves when it comes into contact with the ionic liquid, the water-containing solution or the water-containing mixture.

The total weight of the oxygen source relative to the total weight of the composition according to the invention can be at least 5% by weight and at most 90% by weight, in particular at least 20% by weight and at most 80% by weight. The total weight of the ionic liquid relative to the total weight of the composition according to the invention can be at least 0.5% by weight and at most 25% by weight, in particular at least 2% by weight and at most 15% by weight. The remaining part of the composition consists of the water-containing solution or the water-containing mixture and optionally the further constituent. The inventors have found that a relatively high total weight of the ionic liquid relative to the total weight of the composition according to the invention ensures a relatively uniform generation of oxygen over a relatively long period of time.

The oxygen source, the ionic liquid, the further salt or the further salt and the antifreeze of the water-containing solution, the antifreeze of the water-containing mixture, the water-containing solution and/or the water-containing mixture of the composition according to the invention can be present in a kit. The kit can also comprise every further constituent, especially the additive, that is optionally comprised by the composition according to the invention.

With the above and other objects in view there is also provided, in accordance with the invention, an oxygen generator, in particular for generating breathable oxygen, in particular for use in emergencies such as for example in an emergency rescue system. The oxygen generator comprises a first and a second compartment, an opening for releasing or a conduit for discharging oxygen formed in the oxygen generator and all constituents of the composition according to the invention. The oxygen source and the ionic liquid are present in the first compartment and the water-containing solution or the water-containing mixture is present in the second compartment. The oxygen generator comprises a physical barrier that separates the first compartment from the second compartment and a means for overcoming the physical barrier, wherein the physical barrier is arranged such that the oxygen source, the ionic liquid and the water-containing solution or the water-containing mixture after overcoming the physical barrier come into contact with one another. The opening or conduit is arranged such that oxygen forming as a result exits through the opening or through the conduit.

The physical barrier can be a valve that can be opened. The physical barrier can also be a membrane or a film/foil, where a device for overcoming the physical barrier is a device for removing, destroying or piercing the membrane or film/foil, such as a blade or a sharp object. The film/foil can be a plastics film or a metal foil.

The constituents, present in the oxygen generator, of the composition according to the invention can comprise, besides the oxygen source, the ionic liquid and the water-containing solution or the water-containing mixture, optionally each of the abovementioned further constituents of the composition according to the invention, in particular the additive. The additive can be present either in the first compartment or in the second compartment.

The oxygen generator can additionally comprise at least one delaying means. The delaying means can be arranged and in particular configured such that a total amount of the water-containing solution present in the oxygen generator or a total amount of the water-containing mixture present in the oxygen generator, after overcoming the physical barrier, comes into contact only gradually with a total amount of the oxygen source present in the oxygen generator. The delaying means can be a semipermeable, i.e., gas-permeable and liquid-impermeable, membrane that surrounds the oxygen source and has at least one hole that limits the supply of liquid, or a bulk material, in particular sand or glass beads, which surrounds or covers the oxygen source or is mixed with the oxygen source and is inert with respect to the oxygen source and either the water-containing solution or the water-containing mixture. Limiting the supply of liquid has the result of delaying the oxygen source surrounded by the membrane from coming into contact with the solution or mixture, but does not restrict the exit of oxygen as a result of the semipermeability of the membrane. The inventors have found that the delaying means prevents a relatively rapid decomposition of the oxygen source in particular as a result of the entire oxygen source rapidly coming into contact with the entire water-containing solution or with the entire water-containing mixture. In addition, floating and/or foaming of the oxygen source during the reaction for generating oxygen in the ionic liquid, in the water-containing solution and/or in the water-containing mixture, can be prevented. This promotes a relatively uniform release of oxygen over a relatively long period of time.

With the above and other objects in view there is also provided, in accordance with the invention, a method for generating oxygen, in particular breathable oxygen, in particular for use in emergencies such as for example in an emergency rescue system. The method comprises providing the oxygen source, the ionic liquid and the water-containing solution or the water-containing mixture of the composition according to the invention and optionally the additive of the composition according to the invention and bringing these into contact with one another.

The oxygen source, the ionic liquid and the water-containing solution or the water-containing mixture can be provided and/or brought into contact with one another at a temperature in a range from −70° C. to +110° C., in particular in a range from −60° C. to +70° C., in particular in a range from −50° C. to +50° C., in particular in a range from −40° C. to 0° C., in particular in a range from −40° C. to −20° C. The inventors have found that, by bringing the oxygen source, the ionic liquid and the water-containing solution or the water-containing mixture into contact with one another even at a relatively low temperature, in particular at a temperature in a range from −40° C. to −20° C., oxygen is immediately generated by the composition according to the invention.

The inventors have also found that the method according to the invention ensures scalable generation of oxygen. The inventors have additionally found that the method according to the invention ensures a continuous and uniform generation of oxygen within a relatively broad temperature range, in particular in a temperature range from −40° C. to +70° C. The inventors have additionally found that the method according to the invention ensures the generation of oxygen without respiratory poisons, in particular without carbon monoxide, without ammonia, without chlorine and without a chlorine compound.

The invention further relates to a use of the oxygen source, the ionic liquid and the water-containing solution or the water-containing mixture of the composition according to the invention and optionally of the additive of the composition according to the invention for the generation of oxygen, in particular breathable oxygen, in particular for use in emergencies such as in an emergency rescue system. The use according to the invention can be a use in a hermetically sealed environment, such as for example in a submarine or a space capsule, or in an emergency situation, such as for example in the event of a sudden loss of pressure in an aircraft.

All of the features specified in the description are to be understood to be features that are applicable to all of the embodiments of the invention. In other words, any feature specified for the composition can also be applied to the oxygen generator, the method according to the invention and/or the use according to the invention, and vice versa.

Other features which are considered as characteristic for the invention are set forth in the appended claims.

Although the invention is illustrated and described herein as embodied in a composition for generating oxygen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a graphical representation of the decomposition of potassium superoxide in ambient air as a function of the formulation and the reaction time;

FIG. 2 shows a schematic experimental setup for determining the decomposition;

FIG. 3 shows a ¹⁹F NMR spectrum of the ionic liquid prior to and after the release of oxygen from potassium superoxide;

FIG. 4 shows an ¹¹B NMR spectrum of the ionic liquid prior to and after the release of oxygen from potassium superoxide;

FIG. 5 shows a graphical representation of the volume of oxygen released during the reactions for releasing oxygen with and without ionic liquid, as a function of the reaction time;

FIG. 6 shows a graphical representation of the oxygen flow rates as a function of the reaction time during reactions for releasing oxygen with and without ionic liquid;

FIG. 7 shows a graphical representation of the volume of oxygen released during the reaction for releasing oxygen as a function of the reaction time;

FIG. 8 shows a graphical representation of the volume of oxygen released during the reactions for releasing oxygen as a function of the aqueous solution and of the reaction time;

FIG. 9 shows a graphical representation of the volume of oxygen released during the reactions for releasing oxygen as a function of the ambient temperature and of the reaction time;

FIG. 10 shows a graphical representation of the oxygen flow rates as a function of the ambient temperature and of the reaction time during reactions for releasing oxygen;

FIG. 11 shows a further graphical representation of the volume of oxygen released during the reactions for releasing oxygen with and without ionic liquid, as a function of the reaction time;

FIG. 12 shows a further graphical representation of the oxygen flow rates as a function of the reaction time during reactions for releasing oxygen with and without ionic liquid;

FIG. 13 shows a further graphical representation of the volume of oxygen released during the reaction for releasing oxygen as a function of the reaction time;

FIG. 14 shows a further graphical representation of the oxygen flow rate as a function of the reaction time during the reaction for releasing oxygen;

FIG. 15 shows a graphical representation of the volume of oxygen released during the reactions for releasing oxygen as a function of the ionic liquid and of the reaction time; and

FIG. 16 shows a graphical representation of the oxygen flow rates as a function of the ionic liquid and of the reaction time during reactions for releasing oxygen.

The acronym “IL” used in the figures and in the text below stands for “ionic liquid.”

### DETAILED DESCRIPTION OF THE INVENTION

### First Exemplary Embodiment

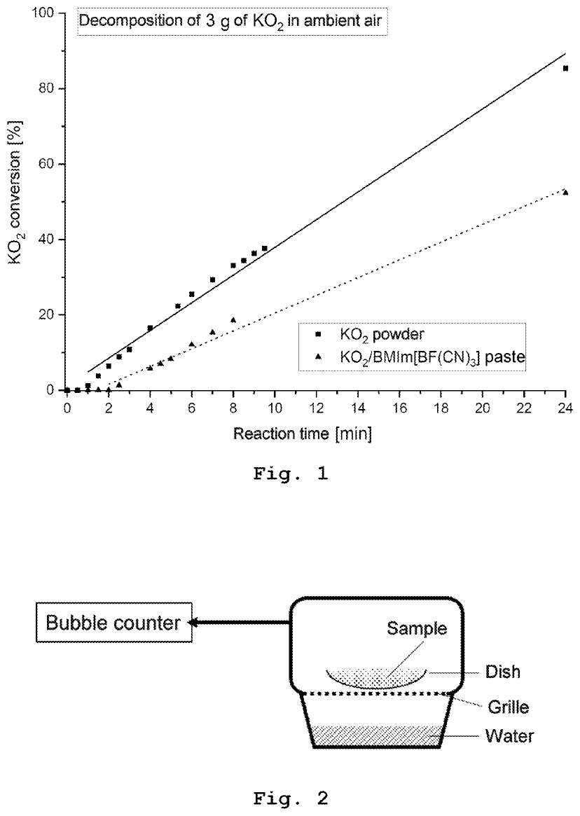

Two sealed reaction vessels were each adjusted to a temperature of 19.5° C. and each filled with 2 mL of distilled water. Then, either 3 g of pulverulent potassium superoxide or 6 g of a paste consisting of 3 g of potassium superoxide and 3 g of ionic liquid [BMIm][BF(CN)₃] were added to one each of the reaction vessels such that they were not in contact with the distilled water. The reaction vessels were each incubated at 19.5° C. for 24 hours. The amount of gas released was determined in each case with a bubble counter. The ionic liquid was analysed prior to and after the reaction by means of ¹⁹F NMR spectroscopy and ¹¹B NMR spectroscopy. The results are presented in FIGS. 1, 3 and 4 and in Table 1. A schematic experimental setup is presented in FIG. 2.

TABLE 1

| | | O₂ evolution | |
|---|---|---|---|
| | O₂ evolution | detected after | KO₂ conversion |
| Oxygen source | detected after [h] | 24 h [mL] | after 24 h [%] |
| KO₂ powder | 1 | 670 | 89 |
| KO₂/IL paste | 2.5 | 410 | 54 |

It is apparent from FIG. 1 and Table 1 that in the case of potassium superoxide as a powder the decomposition of the potassium superoxide begins after one hour. It is additionally apparent that after 24 hours of incubation time, 89% by weight of the employed potassium superoxide has decomposed. The decomposition of the potassium superoxide in the paste begins after 2.5 hours. It is additionally apparent that after 24 hours of incubation time, 54% by weight of the employed potassium superoxide in the paste has decomposed. A paste consisting of potassium superoxide and ionic liquid increases the stability of the potassium superoxide in a humid atmosphere.

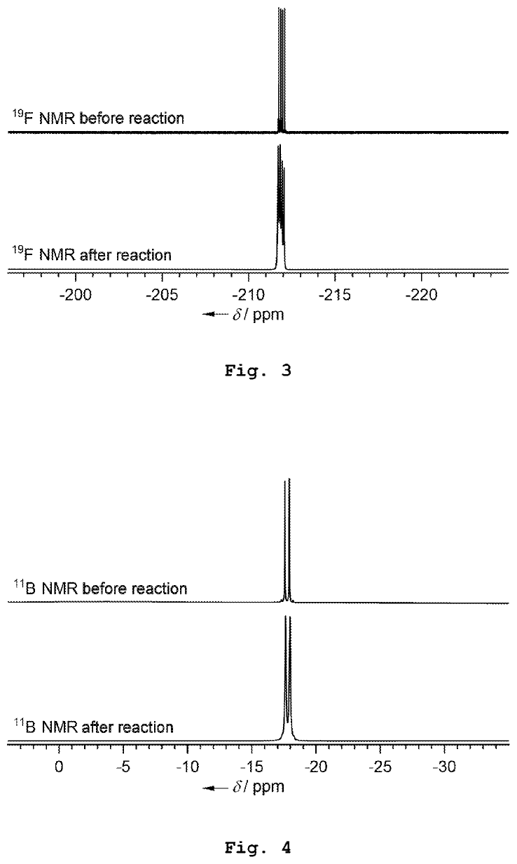

It is apparent from FIGS. 3 and 4 that there are no differences in the ¹⁹F and ¹¹B NMR spectra of the ionic liquid [BMIm][BF(CN)₃] prior to and after the above decomposition reaction. The ionic liquid does not take part in the reaction for releasing oxygen and is not chemically altered by this reaction.

### Second Exemplary Embodiment

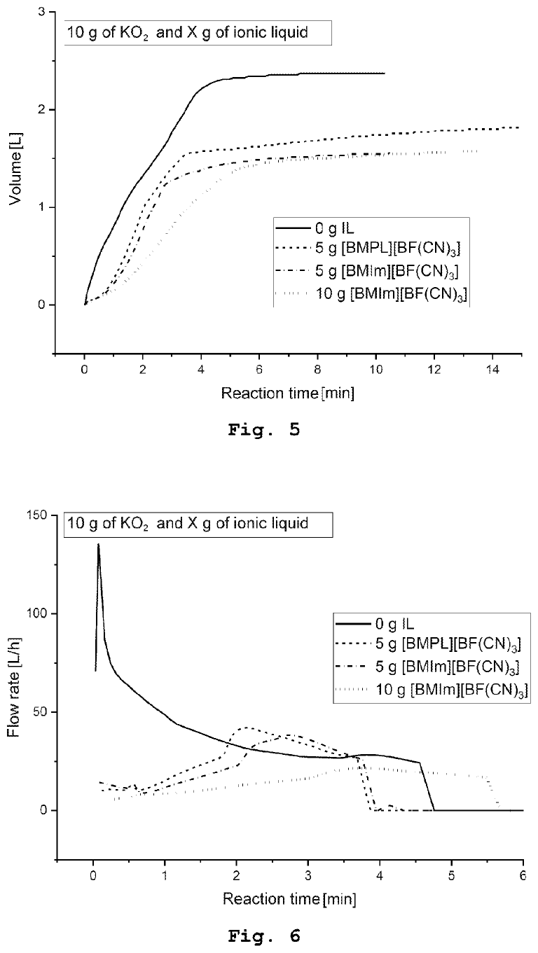

10 g in each case of pulverulent potassium superoxide were initially charged as oxygen source into four cylindrical reaction vessels having an internal diameter of 28 mm. Either 5 g of [BMPL][BF(CN)₃], 5 g of [BMIm][BF(CN)₃] or 10 g of [BMIm][BF(CN)₃] were added. In one reaction vessel, no ionic liquid was added. Next, at an ambient temperature of room temperature, the reaction for generating oxygen was initiated by adding 20 mL in each case of a 9 M potassium hydroxide solution. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The reaction was terminated after 15 minutes. The results are presented in FIGS. 5 and 6 and in Table 2.

TABLE 2

| | | | After 10 minutes of | |
|---|---|---|---|---|
| | | | reaction time | |
| | Flow rateₘₐₓ | ReactionTemp. | O₂ volume | O₂ volume |
| Ionic liquid | [L/h] | [° C.] | [L] | [%] |
| Without | 135 | 49 | 2.37 | 95 |
| 5 g of [BMIm][BF(CN)₃] | 38 | 32 | 1.55 | 61 |
| 10 g of [BMIm][BF(CN)₃] | 21 | 28 | 1.53 | 61 |
| 5 g of [BMPL][BF(CN)₃] | 42 | 31 | 1.74 | 70 |

It is apparent from this that, without the addition of an ionic liquid, the maximum yield in gas volume of 2.37 L is reached after 10 minutes of reaction time. Addition of 5 g of [BMIm][BF(CN)₃] results in a maximum yield in gas volume of 1.55 L being reached after 10 minutes of reaction time. Addition of 10 g of [BMIm][BF(CN)₃] results in a maximum yield of 1.55 L being reached after 10 minutes of reaction time. Addition of 5 g of [BMPL][BF(CN)₃] results in a maximum yield of 1.82 L being reached. This reaction was terminated after 15 minutes. The maximum gas volume that can theoretically be generated in this reaction is 2.51 L. The flow curve profile ascertained via the measured flow rates has a markedly more plateau-shaped course as a result of the addition of the ionic liquid. As a result of the addition of the ionic liquid, the oxygen is released more continuously and more uniformly.

### Third Exemplary Embodiment

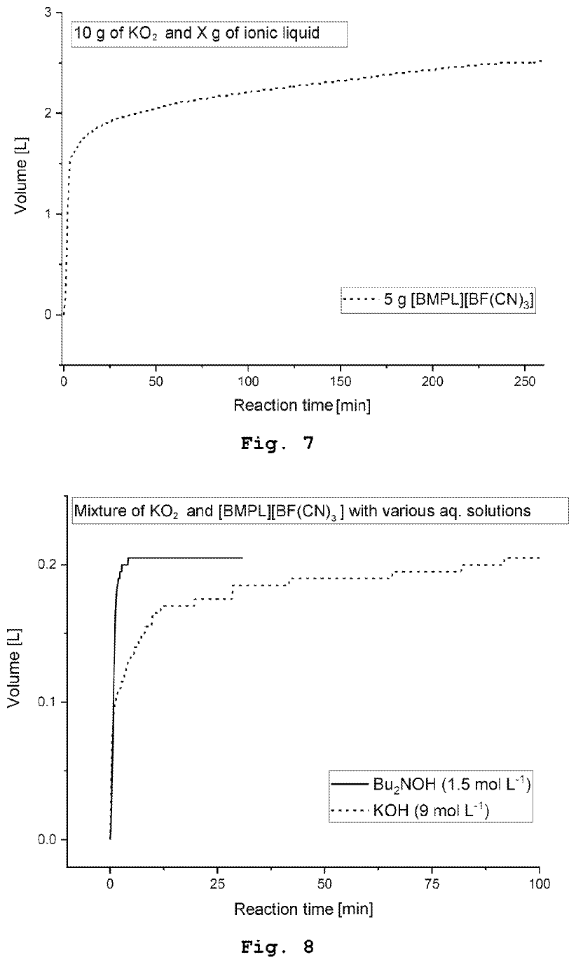

10 g of pulverulent potassium superoxide were initially charged as oxygen source into a cylindrical reaction vessel having an internal diameter of 28 mm. 5 g of [BMPL][BF(CN)₃] were added. Next, at an ambient temperature of room temperature, the reaction for generating oxygen was initiated by adding 20 mL in each case of a 9 M potassium hydroxide solution. The reaction vessel was sealed and the oxygen released by the reaction for generating oxygen was guided through a drum-type gas meter to measure the volume of the oxygen generated from the reaction vessel. The oxygen flow rate and the length of the reaction time until complete conversion of the potassium superoxide were additionally measured. The result is presented in FIG. 7. It is apparent from this that, with the addition of [BMPL][BF(CN)₃], the maximum yield in gas volume of 2520 mL is reached after 260 minutes. As a result of the addition of the ionic liquid [BMPL][BF(CN)₃], the oxygen is released continuously and uniformly over a long reaction time period.

### Fourth Exemplary Embodiment

1 g in each case of pulverulent potassium superoxide was initially charged as oxygen source into two cylindrical reaction vessels having an internal diameter of 24 mm. 0.5 g of [BMPL][BF(CN)₃] were added in each case. Next, at an ambient temperature of room temperature, the reaction for generating oxygen was initiated by adding either 2 mL of a 9 M potassium hydroxide solution or 2 mL of an aqueous 1.5 M tetrabutylammonium hydroxide solution. The reaction vessels were each sealed and the oxygen released by the reaction for generating oxygen was guided through a drum-type gas meter to measure the volume of the oxygen generated from the reaction vessels. The length of the reaction time was additionally measured. The reaction was terminated after 100 minutes. The results are presented in FIG. 8. It is apparent from this that, without the addition of an aqueous tetrabutylammonium hydroxide solution, the maximum yield in gas volume of 0.21 L is reached after 4 minutes of reaction time. The addition of an aqueous potassium hydroxide solution results in the maximum yield in gas volume of 0.21 L being reached after 93 minutes of reaction time. As a result of the addition of the aqueous potassium hydroxide solution, the oxygen is released over a longer period of time.

### Fifth Exemplary Embodiment

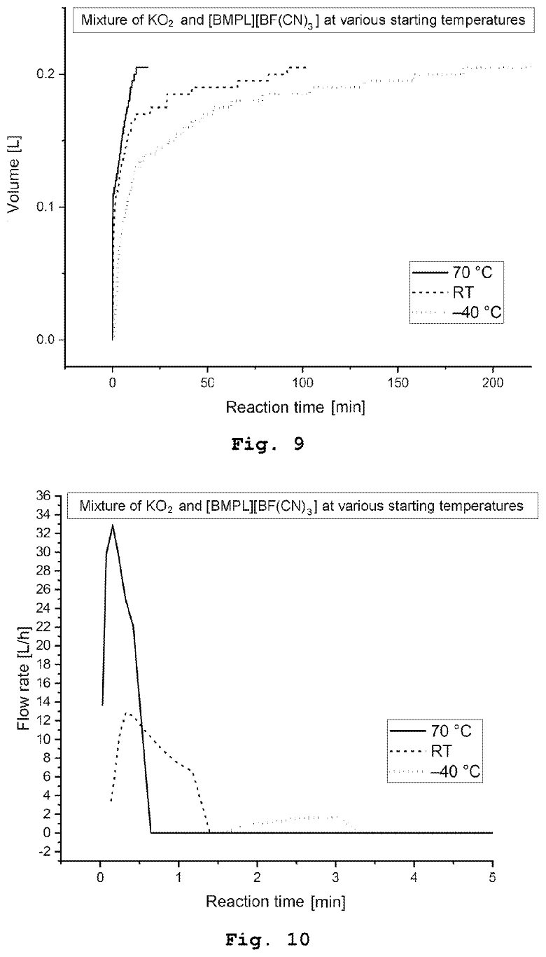

0.5 g of [BMPL][BF(CN)₃] were in each case added to 1 g of pulverulent potassium superoxide as oxygen source in three cylindrical reaction vessels having an internal diameter of 24 mm. At an ambient temperature of +70° C., room temperature or −40° C., the reaction for generating oxygen was initiated by adding 2 mL in each case of an aqueous 9 M potassium hydroxide solution that had been adjusted to the respective ambient temperature. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The results are presented in FIGS. 9 and 10 and in Table 3.

TABLE 3

| Starting temperature | Flow rateₘₐₓ | Reaction duration |
|---|---|---|
| [° C.] | [L/h] | [min] |
| −40 | 2 | 186 |
| RT | 13 | 87 |
| 70 | 33 | 13 |

It is apparent from this that, at an ambient temperature of 70° C., the maximum yield in gas volume of 0.21 L is reached after 13 minutes of reaction time. At an ambient temperature of room temperature, the maximum yield in gas volume of 0.21 L is reached after 87 minutes of reaction time. At an ambient temperature of −40° C., the maximum yield in gas volume of 0.21 L is reached after 186 minutes of reaction time. The flow curve profile ascertained via the measured flow rates has a markedly more plateau-shaped course at an ambient temperature of −40° C. As a result of an ambient temperature of −40° C., the oxygen is released more continuously and uniformly.

### Sixth Exemplary Embodiment

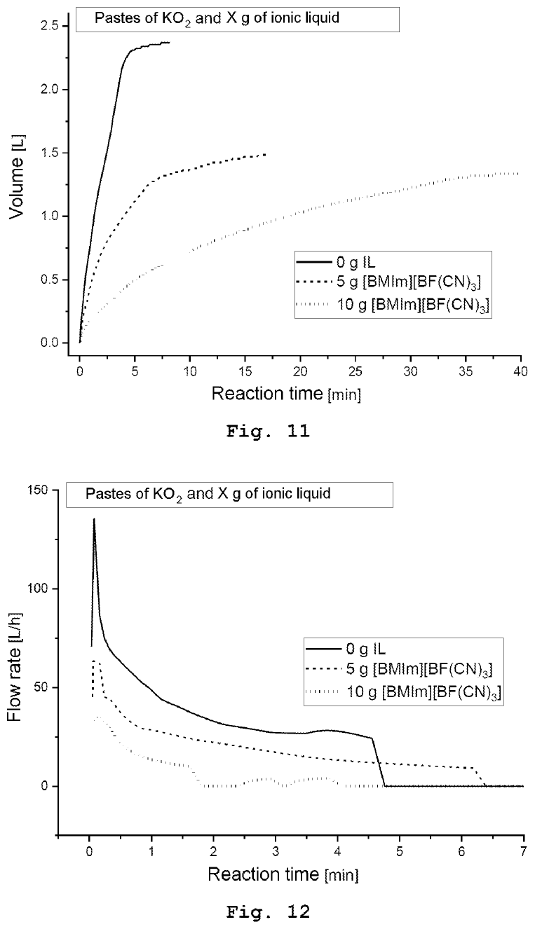

10 g of pulverulent potassium superoxide were initially charged as oxygen source in a cylindrical reaction vessel having an internal diameter of 28 mm. A further cylindrical reaction vessel having an internal diameter of 28 mm was initially charged with 15 g of a paste consisting of 10 g of potassium superoxide as oxygen source and 5 g of [BMIm][BF(CN)₃]. A further cylindrical reaction vessel having an internal diameter of 28 mm was initially charged with 20 g of a paste consisting of 10 g of potassium superoxide as oxygen source and 10 g of [BMIm][BF(CN)₃]. Next, at an ambient temperature of room temperature, the reaction for generating oxygen was initiated by adding 20 mL in each case of a 9 M potassium hydroxide solution. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The results are presented in FIGS. 11 and 12 and in Table 4.

TABLE 4

| | | | After 10 minutes of reaction | |
|---|---|---|---|---|
| | | Reaction | time | |
| | Flow rateₘₐₓ | temperature | O₂ volume | O₂ volume |
| IL | [L/h] | [° C.] | [L] | [%] |
| Without | 135 | 49 | 2.37 | 95 |
| 5 g of IL | 63 | 29 | 1.47 | 58 |
| 10 g of IL | 36 | 26 | 0.90 | 35 |

It is apparent from this that, with pulverulent potassium superoxide, the maximum yield in gas volume of 2.37 L is reached after 8 minutes of reaction time. With the paste consisting of 10 g of potassium superoxide and 5 g of [BMIm][BF(CN)₃], a yield of 1.47 L is reached after 10 minutes of reaction time. With the paste consisting of 10 g of potassium superoxide and 10 g of [BMIm][BF(CN)₃], a yield of 0.90 L is reached after 10 minutes of reaction time. The maximum gas volume that can theoretically be generated in this reaction is 2.51 L. The flow curve profile ascertained via the measured flow rates has a markedly more plateau-shaped course in the case of the pastes consisting of potassium superoxide and [BMIm][BF(CN)₃]. In the case of the pastes consisting of potassium superoxide and [BMIm][BF(CN)₃], the oxygen is released more continuously and more uniformly. The oxygen is released more continuously and more uniformly the greater the total weight of the ionic liquid is in relation to the total weight of the oxygen source. As a result of the use of ionic liquids in various concentrations, the flow rates of the oxygen generated can be varied within wide limits and thus the reaction duration can be prolonged as desired from a few minutes up to several hours.

### Seventh Exemplary Embodiment

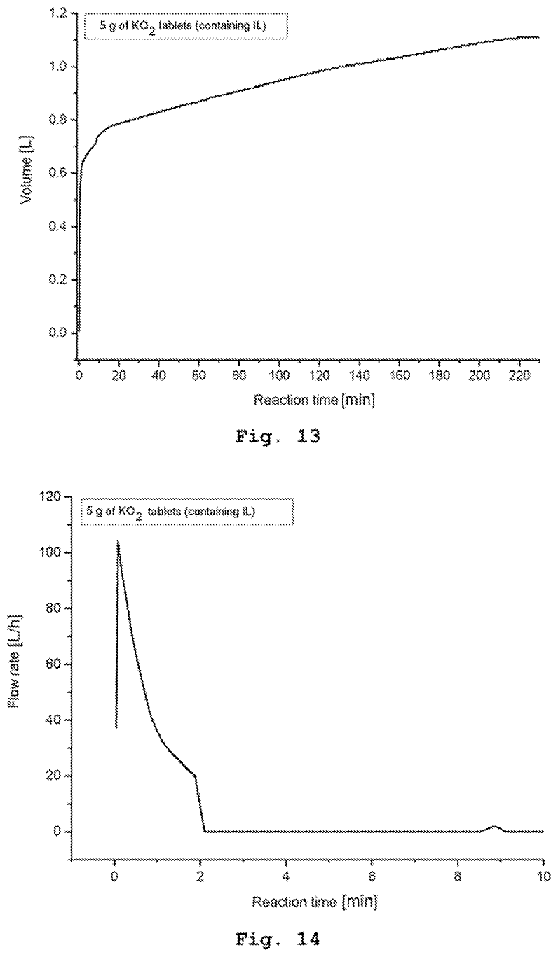

4.55 g of potassium superoxide and 0.45 g of [BMPL][BF(CN)₃] were pressed into tablets. 5 g of these tablets were initially charged in a cylindrical reaction vessel having an internal diameter of 28 mm. Next, at an ambient temperature of room temperature, the reaction for generating oxygen was initiated by adding 10 mL of a 9 M potassium hydroxide solution. The reaction vessel was sealed and the oxygen released by the reaction for generating oxygen was guided through a drum-type gas meter to measure the volume of the oxygen generated from the reaction vessel. The oxygen flow rate and the length of the reaction time were additionally measured. The reaction was terminated after 225 minutes. The results are presented in FIGS. 13 and 14 and in Table 5.

TABLE 5

| Flow rateₘₐₓ | Reaction temp. | O₂ volume | O₂ volume | Reaction |
|---|---|---|---|---|
| [L/h] | [° C.] | [L] | [%] | duration [min] |
| 104 | 27 | 1.11 | 94 | 219 |

It is apparent from this that, in the case of potassium superoxide and [BMPL][BF(CN)₃], pressed into tablets, the yield in gas volume of 1.11 L is reached after 219 minutes of reaction time. The maximum gas volume that can theoretically be generated in this reaction is 1.14 L. It is apparent from the flow curve profile ascertained via the measured flow rates that immediately after addition of the aqueous potassium hydroxide solution a maximum flow rate of 104 L per hour is reached. After the maximum flow rate has been reached, the flow rate decreases continuously.

### Eighth Exemplary Embodiment

An open reaction vessel was initially charged with 2 g of pulverulent potassium superoxide and 4 g of a paste consisting of 2 g of potassium superoxide and 2 g of [BMPL][BF(CN)₃]. The reaction vessels were each adjusted to an ambient temperature of +70° C. and held at this ambient temperature for 24 hours. No weighable loss of weight was detected in either sample after 24 h at +70° C. ambient temperature.

### Ninth Exemplary Embodiment

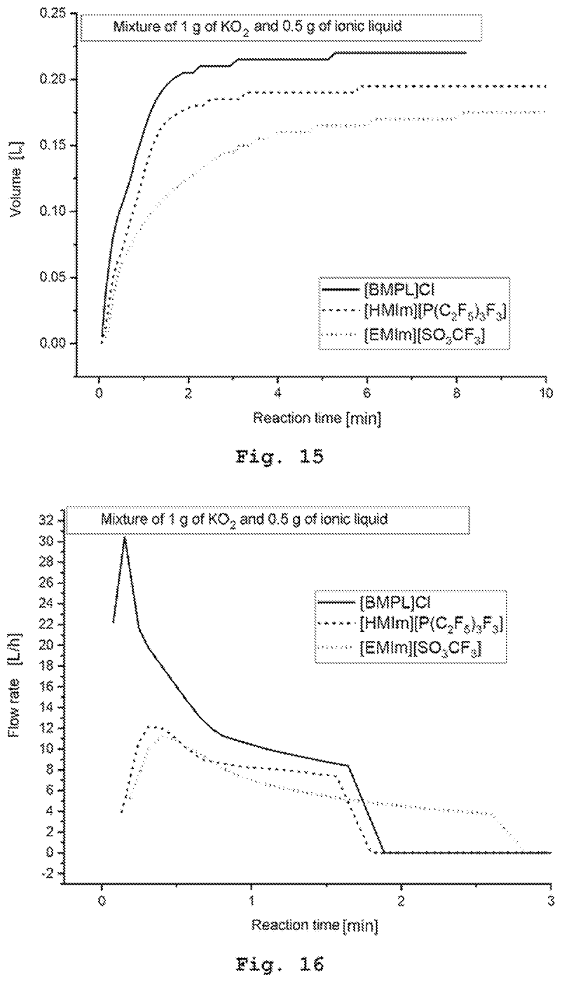

1 g in each case of pulverulent potassium superoxide was initially charged as oxygen source into three cylindrical reaction vessels having an internal diameter of 24 mm. Either 0.5 g of [BMPL]Cl, 0.5 g of [HMIm][P(C₂F₅)₃F₃] or 0.5 g of [EMIm][SO₃CF₃] were added. In contrast to the ionic liquid [BMPL]Cl, the ionic liquids [HMIm][P(C₂F₅)₃F₃] or [EMIm][SO₃CF₃] contain relatively hydrophobic anions. Next, at an ambient temperature of room temperature, the reaction for generating oxygen was initiated by adding 2 mL in each case of a 9 M potassium hydroxide solution. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The reactions were terminated after 75 minutes. The results are presented in FIGS. 15 and 16 and in Table 6.

TABLE 6

| | | After 10 minutes of reaction | |
|---|---|---|---|
| | | time | |
| | Flow rateₘₐₓ | O₂ volume | O₂ volume |
| Ionic liquid | [L/h] | [mL] | [%] |
| [BMPL]CI | 30 | 220 | 87 |
| [HMIm][P(C₂F₅)₃F₃] | 12 | 195 | 78 |
| [EMIm][SO₃CF₃] | 11 | 175 | 70 |

It is apparent from this that, with the addition of [BMPL]Cl, the maximum yield in gas volume of 220 mL is reached after 5 minutes of reaction time. The addition of [HMIm][P(C₂F₅)₃F₃] results in the maximum yield in gas volume of 200 mL being reached after 26 minutes of reaction time. The addition of [EMIm][SO₃CF₃] results in the maximum yield in gas volume of 190 mL being reached after 41 minutes of reaction time. The maximum gas volume that can theoretically be generated in this reaction is 250 mL. The flow curve profile ascertained via the measured flow rates has a markedly more plateau-shaped course as a result of addition of the ionic liquids [HMIm][P(C₂F₅)₃F₃] and [EMIm][SO₃CF₃] having hydrophobic anions. As a result of the addition of an ionic liquid having hydrophobic anions, the oxygen is released more continuously and more uniformly.

### Tenth Exemplary Embodiment

1 g in each case of pulverulent potassium superoxide was initially charged as oxygen source into three cylindrical reaction vessels having an internal diameter of 24 mm. Either 0.5 g of [BMPL]Cl, 0.5 g of [HMIm][P(C₂F₅)₃F₃] or 0.5 g of [EMIm][SO₃CF₃] were added. In contrast to the ionic liquid [BMPL]Cl, the ionic liquids [HMIm][P(C₂F₅)₃F₃] or [EMIm][SO₃CF₃] contain relatively hydrophobic anions. Next, the reaction for generating oxygen was initiated at an ambient temperature of −20° C. by adding 2 mL in each case of a 40% aqueous propylene glycol mixture that had been adjusted to an ambient temperature of −20° C. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The reactions were terminated after 75 minutes. The volume of the oxygen generated and the flow curve profile ascertained via the measured flow rates are similar to the results shown in exemplary embodiment 9. Here too, as a result of the addition of an ionic liquid having hydrophobic anions, the oxygen is released more continuously and more uniformly.

### Eleventh Exemplary Embodiment

1 g in each case of pulverulent potassium superoxide was initially charged as oxygen source into three cylindrical reaction vessels having an internal diameter of 24 mm. Either 0.5 g of [BMPL]Cl, 0.5 g of [HMIm][P(C₂F₅)₃F₃] or 0.5 g of [EMIm][SO₃CF₃] were added. In contrast to the ionic liquid [BMPL]Cl, the ionic liquids [HMIm][P(C₂F₅)₃F₃] or [EMIm][SO₃CF₃] contain relatively hydrophobic anions. Next, the reaction for generating oxygen was initiated at an ambient temperature of −20° C. by adding 2 mL in each case of a 50% aqueous ethylene glycol mixture that had been adjusted to an ambient temperature of −20° C. The reaction vessels were each sealed and the oxygen released by the reaction for generating oxygen was guided through a drum-type gas meter to measure the volume of the oxygen generated from the reaction vessels. The oxygen flow rates and the length of the reaction time were additionally measured. The reactions were terminated after 75 minutes. The volume of the oxygen generated and the flow curve profile ascertained via the measured flow rates are similar to the results shown in exemplary embodiment 9. Here too, as a result of the addition of an ionic liquid having hydrophobic anions, the oxygen is released more continuously and more uniformly.

1. A composition for generating oxygen, comprising:
an oxygen source, said oxygen source being potassium superoxide;
an ionic liquid, said ionic liquid being a salt consisting of at least one cation and at most 100 cations, and at least one anion and at most 100 anions;
a water-containing solution or a water-containing mixture, said water-containing solution containing a given amount of a further salt or a given amount of the further salt together with a given amount of an antifreeze, or the water-containing mixture contains a given amount of an antifreeze, to effectively lower a freezing point of said water-containing solution or of said water-containing mixture by at least 10° C. compared with a freezing point of the water;
said further salt of said water-containing solution being an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two compounds selected from the group consisting of an alkali metal hydroxide, an alkali metal hydroxide hydrate, an alkali metal chloride, an alkali metal chloride hydrate, a hydroxide with an organic cation, and a hydrate of a hydroxide with an organic cation; and
said antifreeze includes an alcohol or consists of an alcohol.

2. The composition according to claim 1, consisting of said oxygen source, said ionic liquid, and said water-containing mixture or said water-containing solution.

3. The composition according to claim 1, wherein:
said cation or one of said cations of said ionic liquid is an ammonium ion, a substituted ammonium ion, a phosphonium ion, a substituted phosphonium ion, an N-monosubstituted or an N-disubstituted pyrrolidinium ion, an N-monosubstituted or an N′,N-disubstituted imidazolium ion or an N-monosubstituted pyridinium ion; and/or
said anion or one of said anions of said ionic liquid is a halide ion, a tetrafluoroborate ion, a hexafluorophosphate ion, a cyanoborate ion, a substituted cyanoborate ion, a sulfonate ion, a bisperfluoroalkylimide ion, a borate ion, a substituted borate ion, a phosphate ion, or a substituted phosphate ion.

4. The composition according to claim 3, wherein:
said substituted ammonium ion is a tetraalkylammonium ion, said substituted phosphonium ion is a tetraalkylphosphonium ion, said substituted cyanoborate ion is a perfluoroalkylcyanoborate ion, said sulfonate ion is a perfluoroalkylsulfonate ion, said substituted borate ion is a perfluoroalkylborate ion, said substituted phosphate ion is a perfluoroalkylphosphate ion or a perfluoroalkylfluorophosphate ion.

5. The composition according to claim 3, wherein a substituent of the N-monosubstituted pyrrolidinium ion, of the N-monosubstituted imidazolium ion and of the N-monosubstituted pyridinium ion, and at least one substituent of the N′,N-disubstituted imidazolium ion, and at least one substituent of the N-disubstituted pyrrolidinium ion, is independently selected from alkyl, in particular methyl, ethyl, propyl or butyl, benzyl and aryl.

6. The composition according to claim 1, wherein said ionic liquid is an ionic liquid that is liquid in a temperature range from −60° C. to +150° C.

7. The composition according to claim 6, wherein said ionic liquid is liquid in a temperature range from −40° C. to +110° C.

8. The composition according to claim 1, wherein said antifreeze comprises or consists of a monohydric alcohol, a dihydric alcohol, a trihydric alcohol, or a mixture of at least two alcohols selected from the group consisting of a monohydric alcohol, a dihydric alcohol, and a trihydric alcohol.

9. The composition according to claim 8, wherein the monohydric alcohol is ethanol or octanol, the dihydric alcohol is propylene glycol or ethylene glycol, and the trihydric alcohol is glycerol.

10. The composition according to claim 1, wherein the alkali metal hydroxide is potassium hydroxide or sodium hydroxide, the alkali metal hydroxide hydrate is a hydrate of potassium hydroxide or a hydrate of sodium hydroxide, the alkali metal chloride is sodium chloride, the alkali metal chloride hydrate is a hydrate of lithium chloride, the hydroxide with the organic cation is a tetraalkylammonium hydroxide, and the hydrate of the hydroxide with the organic cation is a hydrate of a tetraalkylammonium hydroxide.

11. The composition according to claim 10, wherein the tetraalkylammonium hydroxide is a tetrabutylammonium hydroxide and the hydrate of the tetraalkylammonium hydroxide is a hydrate of tetrabutylammonium hydroxide.

12. The composition according to claim 1, wherein a total weight of the further salt or a total weight of the further salt together with the total weight of the antifreeze in the water-containing solution relative to a total weight of the water-containing solution or wherein a total weight of the antifreeze in the water-containing mixture relative to a total weight of the water-containing mixture is at least 25% by weight.

13. The composition according to claim 12, wherein the total weight is at least 30% by weight, or at least 35% by weight, or at least 40% by weight.

14. The composition according to claim 1, further comprising, as a further constituent, at least one additive independently selected from sodium dihydrogenphosphate or potassium hydroxide, an additional substance and an antifoam.

15. The composition according to claim 14, wherein the additional substance is a phyllosilicate or fumed silica.

16. The composition according to claim 12, wherein the antifoam comprises or consists of octanol, paraffin wax or a polysiloxane.

17. An oxygen generator, comprising:
a first and a second compartment, an opening for releasing or a conduit for discharging oxygen formed in the oxygen generator, and the composition according to claim 1;
said oxygen source and said ionic liquid being disposed in said first compartment and said water-containing solution or water-containing mixture being disposed in said second compartment;
a physical barrier configured to separate said first compartment from said second compartment and a device for selectively overcoming said physical barrier, wherein said physical barrier is arranged to enable said oxygen source, said ionic liquid and said water-containing solution or water-containing mixture, after overcoming said physical barrier, to come into contact with one another to release oxygen; and
said opening or conduit being arranged to allow the oxygen being formed to exit through said opening or through said conduit.

18. The oxygen generator according to claim 17, further comprising at least one delaying device disposed and configured to allow a total amount of said water-containing solution present in the oxygen generator or a total amount of said water-containing mixture present in the oxygen generator, after overcoming said physical barrier, to come into contact only gradually with a total amount of said oxygen source present in the oxygen generator.

19. A method of generating oxygen, the method which comprises providing the composition according to claim 1 and bringing the oxygen source, the ionic liquid, and the water-containing solution or the water-containing mixture of the composition, and optionally an additive, an additional substance or an antifoam, into contact with one another.

20. The method according to claim 19, wherein the step of bringing into contact with one another is effected at a temperature in a range from −70° C. to +110° C.
